(19) United States
(12) Patent Application Publication
(10) Pub. No.: US 2017/0367044 A1
(43) Pub. Date: Dec. 21, 2017

(54) BASE STATION, RADIO TERMINAL, AND NETWORK APPARATUS

(71) Applicant: Kyocera Corporation, Kyoto (JP)

(72) Inventors: Masato Fujishiro, Yokohama-shi (JP); Shingo Katagiri, Yokohama-shi (JP); Hiroyuki Adachi, Kawasaki-shi (JP); Kugo Morita, Higashiomi-shi (JP)

(73) Assignee: Kyocera Corporation, Kyoto (JP)

(21) Appl. No.: 15/691,583

(22) Filed: Aug. 30, 2017

Related U.S. Application Data
(63) Continuation of application No. PCT/JP2016/056440, filed on Mar. 2, 2016.

(30) Foreign Application Priority Data
Mar. 3, 2015 (JP) 2015-041868

(51) Int. Cl. H04W 52/02; H04W 4/14; H04W 4/00; H04W 76/04; H04W 68/02; H04W 88/16; H04W 88/02; H04W 88/08

(52) U.S. Cl. CPC H04W 52/0209; H04W 76/048; H04W 4/14; H04W 68/02; H04W 4/005; H04W 76/046; H04W 88/02; H04W 88/08; H04W 88/16

(57) ABSTRACT

A base station according to the present embodiment receives, if the radio terminal is in a connected mode, via a bearer between the base station and a serving gateway, downlink data addressed to the radio terminal, from the serving gateway, and includes a controller configured to transmit the downlink data to the radio terminal. The controller does not release but maintains the bearer, if the extended DRX operation is configured to the radio terminal, when the radio terminal transitions to the idle mode. The controller receives, even if the radio terminal is in the idle mode, from the serving gateway, the downlink data addressed to the radio terminal, via the bearer, and buffers the downlink data until the downlink data is transmitted to the radio terminal.

### RELATED APPLICATIONS

This application is a continuation application of international application PCT/JP2016/056440 (filed Mar. 2, 2016), which claims benefit of Japanese Patent Application No. 2015-041868 (filed on Mar. 3, 2015), the entirety of both applications hereby expressly incorporated by reference.

### TECHNICAL FIELD

The present invention relates to a base station, a radio terminal, and a network apparatus used in a communication system.

### BACKGROUND ART

In 3GPP (3rd Generation Partnership Project), which is a project aiming to standardize a mobile communication system, a discontinuous reception (DRX) is prescribed as an intermittent reception technique to reduce power consumption of a radio terminal. The radio terminal executing a DRX operation intermittently monitors a downlink control channel. A cycle in which the downlink control channel is monitored is referred to as “DRX cycle”.

In recent years, machine-type communication (MTC) in which a radio terminal performs communication without human intervention in a mobile communication system has attracted attention. From such a background, an ongoing discussion is a new introduction of an extended DRX cycle longer than a conventional DRX cycle to further reduce power consumption (for example, see Non Patent Document 1). The DRX using the extended DRX cycle is referred to as “extended DRX”.

By the way, downlink data addressed to the radio terminal is firstly forwarded from an external network to a packet network gateway (hereinafter, POW). The PGW forwards, via an S5/S8 bearer between a serving gateway (hereinafter, SOW) and the PGW, the downlink data to the SOW. The SGW, upon receiving the downlink data, forwards, via an E-RAB bearer between the radio terminal and the SGW, the downlink data to the radio terminal. In this manner, the radio terminal can obtain the downlink data. It is noted that, the E-RAB bearer is constituted of a radio bearer between the radio terminal and a base station, and an S1 bearer between the base station and the SOW.

On the other hand, if the radio terminal is in an idle mode, the S5/S8 bearer between the SGW and the PGW remains present, since the radio terminal is not detached. On the other hand, the E-RAB bearer between the radio terminal and the SGW is not present, since it is released when the radio terminal transitions to the idle mode. In this case, the downlink data addressed to the radio terminal is forwarded, via the S5/S8 bearer, from the PGW to the SOW. The E-RAB bearer is not present, and hence, the SGW requests a mobility management entity (hereinafter, MME) to perform paging. Thereafter, the radio terminal which transitioned to a connected mode based on the paging from the MME establishes the E-RAB bearer between the SGW and the radio terminal. The radio terminal can obtain, via the established E-RAB bearer, the downlink data from the SOW.

### PRIOR ART DOCUMENT

### Non-Patent Document

Non Patent Document 1: 3GPP contribution “RP-141994”

### SUMMARY

A base station according to a first aspect is used in a communication system including a radio terminal capable of configuring an extended DRX in an idle mode. The base station comprises a controller configured to receive, if the radio terminal is in a connected mode, via a bearer between the base station and a serving gateway, downlink data addressed to the radio terminal, from the serving gateway, and to transmit the downlink data to the radio terminal. The controller does not release but maintains the bearer, if the extended DRX operation is configured to the radio terminal, when the radio terminal transitions to the idle mode. The controller receives, even if the radio terminal is in the idle mode, from the serving gateway, the downlink data addressed to the radio terminal, via the bearer, and buffers the downlink data before the downlink data is transmitted to the radio terminal.

A radio terminal according to a second aspect executes a DRX operation in an idle mode. The radio terminal comprises a controller configured to notify a mobility management entity that is an upper node of a base station of a response based on a paging message, if receiving, in the idle mode, the paging message based on downlink data from the base station, after establishing an RRC connection with the base station. The controller omits, if receiving, from the base station, a special paging message different from the paging message, the response and obtains the downlink data from the base station.

A network apparatus according to a third aspect is used in a communication system including a radio terminal capable of executing an extended DRX operation in an idle mode. The network apparatus comprises a controller configured to request a mobility management entity, in response to reception of downlink data addressed to the radio terminal, to perform paging based on the downlink data. The controller forwards, if receiving a negative acknowledgment indicating that the radio terminal is executing the extended DRX operation as a response to the request, the downlink data addressed to the radio terminal to a data server configured to buffer and forward downlink data.

A network apparatus according to a fourth aspect is used in a communication system including a radio terminal capable of executing an extended DRX operation in an idle mode. The network apparatus comprises a receiver configured to receive, from a serving gateway, a paging request based on downlink data addressed to the radio terminal; and a controller configured to notify, in response to the paging request, a paging causing a base station subordinate to the network apparatus to transmit a paging message. The controller executes, if the downlink data addressed to the radio terminal is forwarded from the serving gateway to a data server configured to buffer and forward downlink data, an operation causing the radio terminal to access the data server.

A radio terminal according to a fifth aspect is capable of executing an extended DRX operation in an idle mode. The radio terminal comprises a receiver configured to receive, during execution of the extended DRX operation, a paging message based on downlink data addressed to the radio terminal, from a base station; and a controller configured to establish, after receiving the paging message, an RRC connection with the base station to obtain the downlink data. The receiver receives an access instruction causing the radio terminal to access a data server configured to buffer and forward downlink data. The controller starts the access to the data server in response the access instruction.

### BRIEF DESCRIPTION OF THE DRAWINGS

FIG. 1 is a configuration diagram of an LTE system.

FIG. 2 is a block diagram of a UE.

FIG. 3 is a block diagram of an eNB.

FIG. 4 is a block diagram of an MME.

FIG. 5 is a protocol stack diagram.

FIG. 6 is a configuration diagram of a radio frame.

FIG. 7 is a sequence diagram for describing an operation according to a first embodiment.

FIG. 8 is a diagram for describing an operation environment according to a second embodiment.

FIG. 9 is a sequence diagram for describing an operation according to the second embodiment.

### DESCRIPTION OF THE EMBODIMENT

### Overview of Embodiment

A case where a radio terminal executes an extended DRX operation in an idle mode is assumed. The extended DRX cycle is longer than the conventional DRX cycle, and hence, the radio terminal may be delayed in transitioning to a connected mode, based on a paging from an MME. Therefore, an SGW must buffer downlink data addressed to the radio terminal for a long period until it is transmitted to the radio terminal, and there is a concern that a buffer capacity of the SGW is exceeded. Particularly, depending on the number of base stations subordinate to the SGW, the number of radio terminals to which the downlink data to be forwarded increases. Therefore, if the number of radio terminals configured to execute the extended DRX operation increases, the downlink data to be handled also increases, and hence, if a number of radio terminals execute the extended DRX operation, the buffer capacity of the SGW is more likely to be exceeded.

Therefore, an embodiment provides a base station, a radio terminal, and a network apparatus capable of suppressing an increase in the buffer capacity of the SGW due to buffering of the downlink data addressed to the radio terminal.

A base station according to a first embodiment is used in a communication system including a radio terminal capable of configuring an extended DRX in an idle mode. The base station comprises a controller configured to receive, if the radio terminal is in a connected mode, via a bearer between the base station and a serving gateway, downlink data addressed to the radio terminal, from the serving gateway, and to transmit the downlink data to the radio terminal. The controller does not release but maintains the bearer, if the extended DRX operation is configured to the radio terminal, when the radio terminal transitions to the idle mode. The controller receives, even if the radio terminal is in the idle mode, from the serving gateway, the downlink data addressed to the radio terminal, via the bearer, and buffers the downlink data before the downlink data is transmitted to the radio terminal.

In the first embodiment, the controller transmits, to the radio terminal, a release message for releasing an RRC connection between the radio terminal and the base station without notifying a mobility management entity of a release request serving as a trigger to release the bearer when the radio terminal transitions to the idle mode.

In the first embodiment, the controller transmits, after buffering the downlink data, to the radio terminal, a special paging message transmitted without receiving a paging from a mobility management entity.

In the first embodiment, the controller transmits, to the radio terminal, a paging message including identification information indicating the special paging message, as the special paging message.

A radio terminal according to the first embodiment executes a DRX operation in an idle mode. The user terminal comprises a controller configured to notify a mobility management entity that is an upper node of a base station of a response based on a paging message, if receiving, in the idle mode, the paging message based on downlink data from the base station, after establishing an RRC connection with the base station. The controller omits, if receiving, from the base station, a special paging message different from the paging message, the response and obtains the downlink data from the base station.

In the first embodiment, the controller interprets, if receiving a paging message including identification information indicating the special paging message, the paging message as the special paging message.

A network apparatus according to a second aspect is used in a communication system including a radio terminal capable of executing an extended DRX operation in an idle mode. The network apparatus comprises a controller configured to request a mobility management entity, in response to reception of downlink data addressed to the radio terminal, to perform paging based on the downlink data. The controller forwards, if receiving a negative acknowledgment indicating that the radio terminal is executing the extended DRX operation as a response to the request, the downlink data addressed to the radio terminal to a data server configured to buffer and forward downlink data.

In the second embodiment, the controller forwards the downlink data to the data server, if a predetermined period elapses after buffering the downlink data even if not receiving the negative acknowledgment.

A network apparatus according to the second aspect is used in a communication system including a radio terminal capable of executing an extended DRX operation in an idle mode. The network apparatus comprises a receiver configured to receive, from a serving gateway, a paging request based on downlink data addressed to the radio terminal; and a controller configured to notify, in response to the paging request, a paging causing a base station subordinate to the network apparatus to transmit a paging message. The controller executes, if the downlink data addressed to the radio terminal is forwarded from the serving gateway to a data server configured to buffer and forward downlink data, an operation causing the radio terminal to access the data server.

In the second embodiment, to cause the base station to transmit the paging message including an access instruction causing the radio terminal to access the data server, the controller includes, as the operation, the access instruction into the paging.

In the second embodiment, the controller notifies the radio terminal, by a NAS message, of an access instruction causing the radio terminal to access the data server, as the operation.

In the second embodiment, the controller notifies an SMS server configured to notify, by an SMS message, the radio terminal of an access instruction, of a message that serves as a trigger to notify the access instruction, if receiving, from the radio terminal, a response based on the paging message. The access instruction is an instruction causing the radio terminal to access the data server.

A radio terminal according to the second embodiment is capable of executing an extended DRX operation in an idle mode. The radio terminal comprises a receiver configured to receive, during execution of the extended DRX operation, a paging message based on downlink data addressed to the radio terminal, from a base station; and a controller configured to establish, after receiving the paging message, an RRC connection with the base station to obtain the downlink data. The receiver receives an access instruction causing the radio terminal to access a data server configured to buffer and forward downlink data. The controller starts the access to the data server in response the access instruction.

In the second embodiment, the receiver receives the access instruction by receiving the paging message including the access instruction.

In the second embodiment, the receiver receives the access instruction by a NAS message from a mobility management entity that is an upper node of the base station.

In the second embodiment, the receiver receives, from an SMS server, the access instruction by an SMS message.

### First Embodiment

Hereinafter, a first embodiment when the present disclosure is applied to an LTE system will be described.

(System Configuration)

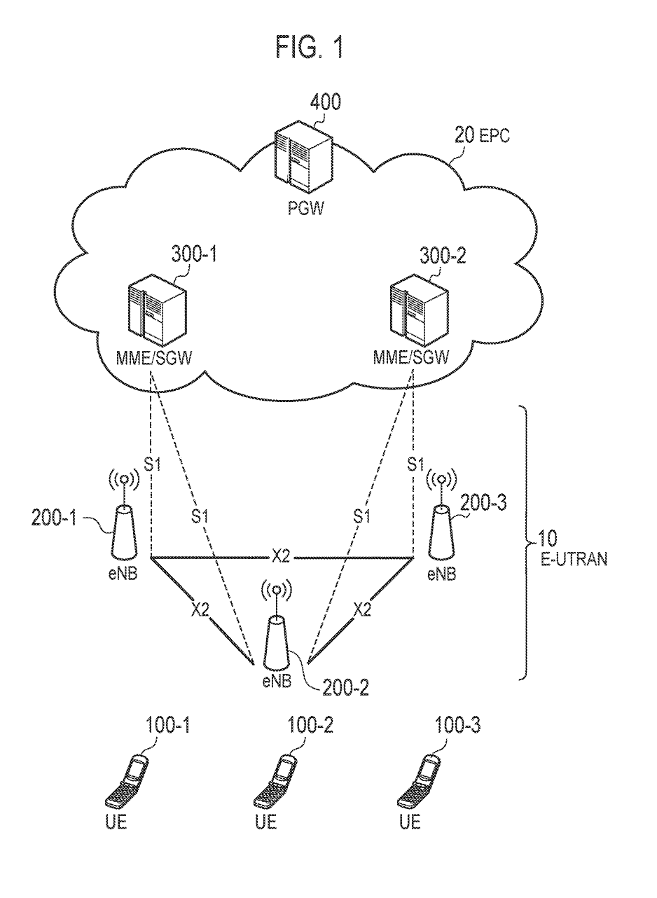

First, system configuration of the LTE system will be described. FIG. 1 is a configuration diagram of an LTE system. As illustrated in FIG. 1, the LTE system according to embodiments includes a plurality of UEs (User Equipments) 100, E-UTRAN (Evolved-Universal Terrestrial Radio Access Network) 10, and EPC (Evolved Packet Core) 20.

The UE 100 corresponds to a radio terminal. The UE 100 is a mobile communication device and performs radio communication with a cell (a serving cell) that connected to the radio terminal. Configuration of the UE 100 will be described later.

The E-UTRAN 10 corresponds to a radio access network. The E-UTRAN 10 includes a plurality of eNBs (evolved Node-Bs) 200. The eNB 200 corresponds to a base station. The eNBs 200 are connected mutually via an X2 interface. Configuration of the eNB 200 will be described later.

The eNB 200 manages one or a plurality of cells and performs radio communication with the UE 100 which establishes a connection with the cell of the eNB 200. The eNB 200 has a radio resource management (RRM) function, a routing function for user data, and a measurement control function for mobility control and scheduling, and the like. It is noted that the “cell” is used as a term indicating a minimum unit of a radio communication area, and is also used as a term indicating a function of performing radio communication with the UE 100.

The EPC 20 corresponds to a core network. The E-UTRAN 10 and the EPC 20 constitute a network (LTE network) of the LTE system. The EPC 20 includes a plurality of MME (Mobility Management Entity)/S-GWs (Serving-Gateways) 300 and a PGW (Packet Data Network Gateway) 400.

A MME 300A and a SGW 300B constitute the MME/S-GW 300. The MME 300A performs various mobility controls and the like for the UE 100. The S-GW 300B performs control to transfer user data. MME/S-GW 300 is connected to eNB 200 via an S1 interface. The MME and the SGW may be configured by the same network apparatus (communication control apparatus) or may be configured by different network apparatuses.

The PGW 400 is a network node that performs control of relaying user data from an external network not managed by an operator of the cellular network and relaying user data to an external network.

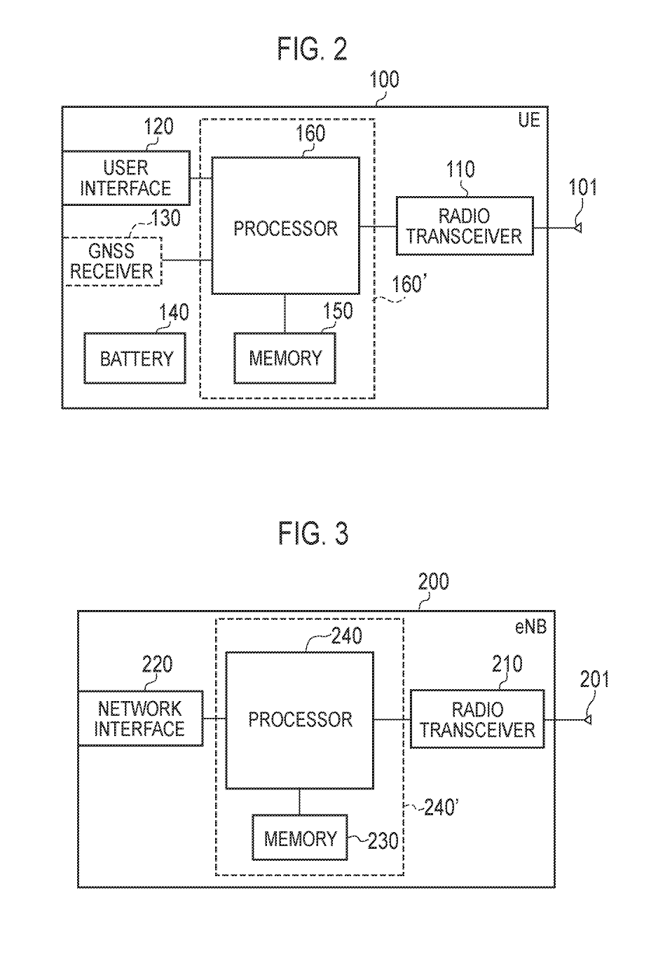

FIG. 2 is a block diagram of the UE 100. As illustrated in FIG. 2, the UE 100 includes plural antennas 101, a radio transceiver 110, a user interface 120, a GNSS (Global Navigation Satellite System) receiver 130, a battery 140, a memory 150, and a processor 160. The memory 150 corresponds a memory, the processor 160 corresponds to a controller. The UE 100 may not include the GNSS receiver 130. Furthermore, the memory 150 may be integrally formed with the processor 160, and this set (that is, a chip set) may be called a processor 160′.

The plural antennas 101 and the radio transceiver 110 are used to transmit and receive a radio signal. The radio transceiver 110 converts a baseband signal (a transmission signal) output from the processor 160 into the radio signal and transmits the radio signal from the antenna 101. Furthermore, the radio transceiver 110 converts a radio signal received by the antenna 101 into a baseband signal (a received signal), and outputs the baseband signal to the processor 160.

The user interface 120 is an interface with a user carrying the UE 100, and includes, for example, a display, a microphone, a speaker, various buttons and the like. The user interface 120 accepts an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates power to be supplied to each block of the UE 100.

The memory 150 stores a program to be executed by the processor 160 and information to be used for a process by the processor 160. The processor 160 includes a baseband processor that performs modulation and demodulation, encoding and decoding and the like on the baseband signal, and CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As illustrated in FIG. 3, the eNB 200 includes plural antennas 201, a radio transceiver 210, a network interface 220, a memory 230, and a processor 240. Furthermore, the memory 230 may be integrally formed with the processor 240, and this set (that is, a chip set) may be called a processor 240′.

The plural antennas 201 and the radio transceiver 210 are used to transmit and receive a radio signal. The radio transceiver 210 converts a baseband signal (a transmission signal) output from the processor 240 into the radio signal and transmits the radio signal from the antenna 201. Furthermore, the radio transceiver 210 converts a radio signal received by the antenna 201 into a baseband signal (a received signal), and outputs the baseband signal to the processor 240.

The network interface 220 is connected to the neighboring eNB 200 via the X2 interface and is connected to the MME/S-GW 300 via the S1 interface. The network interface 220 is used in communication over the X2 interface and communication over the S1 interface.

The memory 230 stores a program to be executed by the processor 240 and information to be used for a process by the processor 240. The processor 240 includes a baseband processor that performs modulation and demodulation, encoding and decoding and the like on the baseband signal and CPU that performs various processes by executing the program stored in the memory 230. The processor 240 executes various processes and various communication protocols described later.

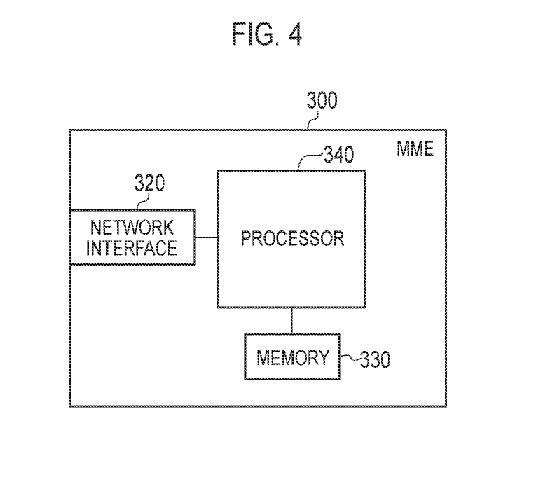

FIG. 4 is a block diagram of the MME 300A. As illustrated in FIG. 4, the MME 300A includes a network interface 320, a memory 330, and a processor 340. The memory 330 may be integrally formed with the processor 340, and this set (that is, a chip set) may be called a processor.

The network interface 320 is connected to the eNB 200 via the S1 interface. The network interface 320 is used for communication performed on the S1 interface.

The memory 330 stores a program to be executed by the processor 340 and information to be used for a process by the processor 340. The processor 340 includes a baseband processor that performs modulation and demodulation, encoding and decoding and the like on the baseband signal and CPU that performs various processes by executing the program stored in the memory 330. The processor 340 executes various processes and various communication protocols described later.

Since the SGW 300B is also a block diagram similar to the MME 300A, its explanation will be omitted. Further, the PGW 400 is a block diagram similar to the MME 300A. However, the network interface of the PGW 400 is connected to each of the MME/SGW 300 and the external network.

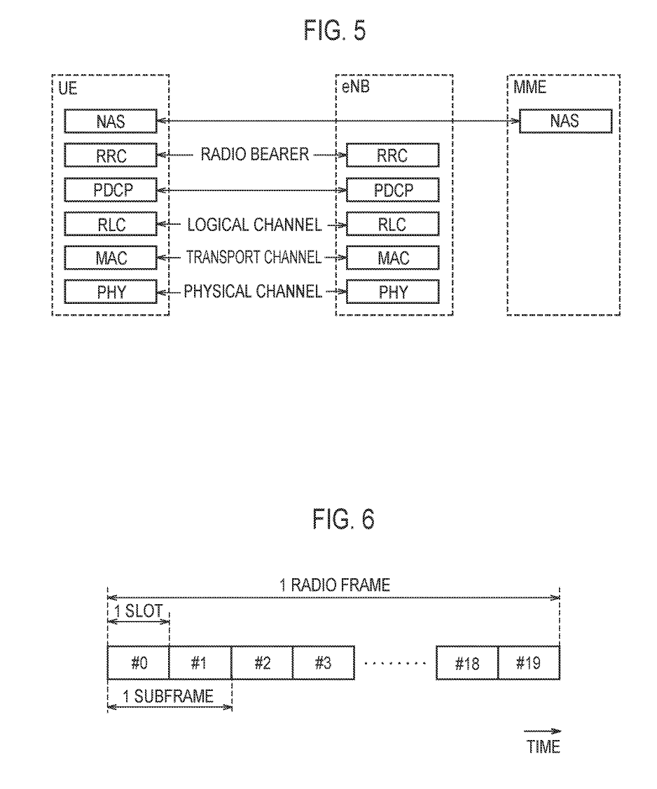

FIG. 5 is a protocol stack diagram of a radio interface in the LTE system. As illustrated in FIG. 5, the radio interface protocol is classified into a layer 1 to a layer 3 of an OSI reference model, wherein the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, user data and control signal are transmitted via the physical channel.

The MAC layer performs priority control of data, a retransmission process by hybrid ARQ (HARQ), and the like. Between the MAC layer of the UE 100 and the MAC layer of the eNB 200, user data and control signal are transmitted via a transport channel. The MAC layer of the eNB 200 includes a scheduler that determines (schedules) a transport format of an uplink and a downlink (a transport block size and a modulation and coding scheme (MCS)) and a resource block to be assigned to the UE 100.

The RLC layer transmits data to an RLC layer of a reception side by using the functions of the MAC layer and the PHY layer. Between the RLC layer of the UE 100 and the RLC layer of the eNB 200, user data and control signal are transmitted via a logical channel.

The PDCP layer performs header compression and decompression, and encryption and decryption.

The RRC layer is defined only in a control plane dealing with control signal. Between the RRC layer of the UE 100 and the RRC layer of the eNB 200, control signal (RRC messages) for various types of configuration are transmitted. The RRC layer controls the logical channel, the transport channel, and the physical channel in response to establishment, re-establishment, and release of a radio bearer. When there is a connection (RRC connection) between the RRC of the UE 100 and the RRC of the eNB 200, the UE 100 is in an RRC connected mode (connected mode), otherwise the UE 100 is in an RRC idle mode (idle mode).

A NAS (Non-Access Stratum) layer positioned above the RRC layer performs a session management, a mobility management and the like.

FIG. 6 is a configuration diagram of a radio frame used in the LTE system. In the LTE system, OFDMA (Orthogonal Frequency Division Multiplexing Access) is applied to a downlink (DL), and SC-FDMA (Single Carrier Frequency Division Multiple Access) is applied to an uplink (UL), respectively.

As illustrated in FIG. 6, a radio frame is configured by 10 subframes arranged in a time direction. Each subframe is configured by two slots arranged in the time direction. Each subframe has a length of 1 ms and each slot has a length of 0.5 ms. Each subframe includes a plurality of resource blocks (RBs) in a frequency direction (not shown), and a plurality of symbols in the time direction. Each resource block includes a plurality of subcarriers in the frequency direction. One symbol and one subcarrier forms one resource element (RE). Of the radio resources (time and frequency resources) assigned to the UE 100, a frequency resource can be constituted by a resource block and a time resource can be constituted by a subframe (or a slot).

(Overview of DRX Operation in Idle Mode)

A discontinuous reception (DRX) operation in the RRC idle mode will be described, below. It is noted that, hereinafter, the DRX operation in the idle mode also includes an operation using the extended DRX cycle longer than the conventional DRX cycle.

The UE 100 can perform the DRX operation to conserve a battery. The UE 100 configured to perform the DRX operation intermittently monitors a PDCCH. Normally, the PDCCH in a subframe carries scheduling information (information on a radio resource and a transport format) of a PDSCH in the sub frame.

The UE 100 in the RRC idle mode performs the DRX operation for intermittently monitoring the PDCCH to receive a paging message notifying that there is an incoming call. The UE 100 uses a group identifier (P-RNTI) for paging to decode the PDCCH (CCE), and obtain assignment information of a paging channel (PI). The UE 100 obtains the paging message, based on the assignment information. A PDCCH monitoring timing in the UE 100 is determined, based on an identifier (International Mobile Subscriber Identity (IMSI)) of the UE 100. A calculation of the PDCCH monitoring timing will be specifically described.

The PDCCH monitoring timing (PDCCH monitoring subframe) in the DRX operation in the RRC idle mode is referred to as “Paging Occasion (PO)”.

The UE 100 (and the eNB 200) calculates the Paging Occasion (PO) and a Paging Frame (PF) which is a radio frame that may include the Paging Occasion, as follows.

A system frame number (SFN) of the PF is evaluated from the following formula (1).

SFN mod T=(T div N)*(UE_ID mod N) (1)

Here, T is a DRX cycle of the UE 100 for receiving the paging message, and is represented by the number of radio frames. N is a minimum value out of T and nB. nB is a value selected from 4T, 2T, T, T/2, T/4, T/8, T/16, and T/32. UE_ID is a value evaluated by “IMSI mod 1024”.

Of the PFs evaluated in this manner, a subframe number of the PO is evaluated as follows. First, index i_s is evaluated by the following formula (2).

i_s=floor (UE_ID/N)mod Ns (2)

Here, Ns is a maximum value out of 1 and nB/T.

Next, the PO corresponding to Ns and the index i_s is obtained from Table 1 or Table 2. Table 1 is applied to an LTE FDD system, and Table 2 is applied to an LTE TDD system. In Table 1 and Table 2, N/A represents not applicable.

TABLE 1

| Ns | PO when l_s = 0 | PO when l_s = 1 | PO when l_s = 2 | PO when l_s = 3 |
|---|---|---|---|---|
| 1 | 9 | N/A | N/A | N/A |
| 2 | 4 | 9 | N/A | N/A |
| 4 | 0 | 4 | 5 | 9 |

TABLE 2

| Ns | PO when l_s = 0 | PO when l_s = 1 | PO when l_s = 2 | PO when l_s = 3 |
|---|---|---|---|---|
| 1 | 0 | N/A | N/A | N/A |
| 2 | 0 | 5 | N/A | N/A |
| 4 | 0 | 1 | 5 | 6 |

In this manner, the UE 100 decides the paging frame, based on the SFN and the DRX cycle. It is noted that the eNB 200 similarly decides a paging frame, and transmits, in the decided paging frame, a PDCCH for notifying a paging message.

### Operation According to First Embodiment

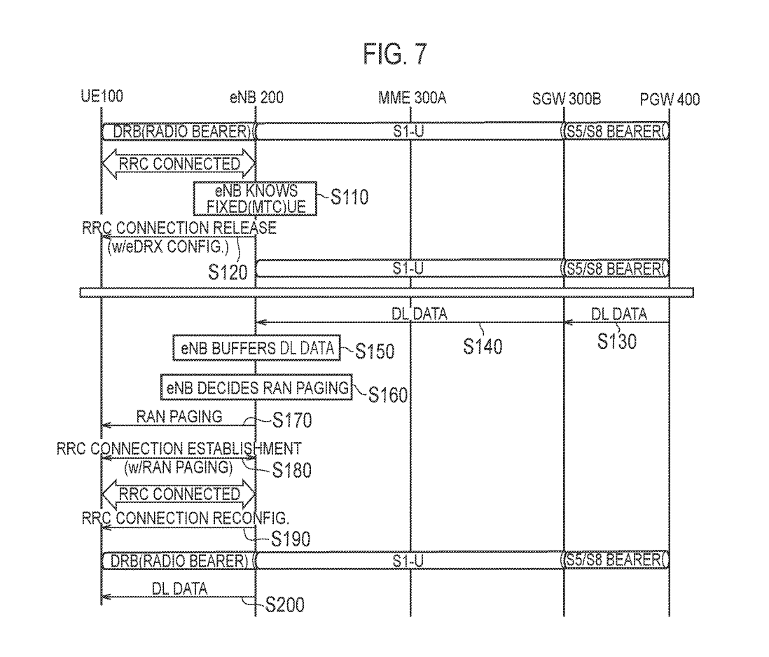

Next, an operation according to the first embodiment will be described with reference to FIG. 7. FIG. 7 is a sequence diagram for describing the operation according to the first embodiment.

The UE 100 exists in a cell managed by the eNB 200. The UE 100 is a radio terminal for the MTC. Specifically, the UE 100 is a radio terminal having a low mobility. For example, the UE 100 is a radio terminal whose location is fixed. Alternatively, the UE 100 is a radio terminal that can only locally move, and moves locally within a cell.

As illustrated in FIG. 7, the UE 100 is, in an initial state, in the connected mode. If the UE 100 communicates with a partner device (Peer Entity) on the Internet (external network), data which the UE 100 transmits and receives is carried by an EPS (Evolved Packet System) bearer between the UE 100 and the PGW 400, and an external bearer between the PWG 400 and the Internet.

The EPS bearer is constituted of an E-RAB between the UE 100 and the SGW 300B, and an S5/S8 bearer between the SGW 300B and the PGW 400 (see FIG. 7). The S5/S8 bearer is established on an S5/S8 interface. If the E-RAB described later is present, the E-RAB corresponds to the EPS bearer one-to-one. The SGW 300B stores a correspondence relationship between the S5/S8 bearer and an S1-U bearer.

The E-RAB is constituted of a data radio bearer (DRB Bearer/Radio Bearer) between the UE 100 and the eNB 200, and the S1-U bearer between the eNB 200 and the SGW 300B.

The S1-U bearer is established on an S1-U interface. If the data radio bearer is present, the data radio bearer corresponds to the EPS bearer/E-RAB one-to-one. The eNB 200 stores a correspondence relationship between the S1-U bearer and the data radio bearer.

Here, if the UE 100 is in the connected mode, the downlink data addressed to the UE 100 is delivered, via the external bearer, to the PGW 400. The PGW 400 forwards, via the S5/S8 bearer, the downlink data to the SGW 300B. Since the S1-U bearer of the UE 100 is present, the SGW 300B, upon receiving the downlink data addressed to the UE 100, forwards, via the S1-U bearer, the downlink data to the eNB 200. The eNB 200, upon receiving the downlink data addressed to the UE 100, transmits, via the data radio bearer, the downlink data to the UE 100. The UE 100 can obtain, by receiving the downlink data from the eNB 200, the downlink data.

Next, if the UE 100 is in the idle mode, a method by which the UE 100 obtains the downlink data, will be described.

As illustrated in FIG. 7, in step S110, the eNB 200 is informed that the UE 100 is a UE having a low mobility. Specifically, the eNB 200 determines, by the following methods, whether or not the UE 100 has the low mobility. The eNB 200 may determine whether or not the UE 100 applies to the MTC.

In a first method, the eNB 200 determines, based on “UEInformationResponse”, whether or not the UE 100 has the low mobility. The eNB 200 transmits, to the UE 100, a message for requesting UE information (UEInformationRequest). The UE 100 transmits, to the eNB 200, a response message (UEInformationResponse) to the message. If the response message includes a mobility history report (mobilityHistoryReport), the eNB 200 determines, based on the mobility history report, whether or not the UE 100 has the low mobility. The mobility history report is information indicating a staying time in a cell in which the UE 100 most recently stayed or a cell that the UE 100 most recently left. If the staying time in the cell where the UE 100 exists (stays) exceeds a threshold value, the eNB 200 determines that the UE 100 has the low mobility. Otherwise, the eN 200 determines that the UE 100 does not have the low mobility.

In a second method, the eNB 200 determines, based on “Expected UE Behaviour”, whether or not the UE 100 has the low mobility. If an “INITIAL CONTEXT SETUP REQUEST” message received from the MME 300A includes the “Expected UE Behaviour” related to a behaviour of the UE 100, the eNB 200 determines, based on the “Expected UE Behaviour”, whether or not the UE 100 has the low mobility. The “Expected UE Behaviour” is information indicating a predicted active behaviour and/or mobility behaviour of the UE. For example, the “Expected UE Behaviour” is information indicating an active time and/or idle time of the UE 100. The “Expected UE Behaviour” is information indicating a predicted time interval of inter-base station handovers (inter-eNB handovers). If “long-time” is included in the “Expected UE Behaviour”, the interval of the inter-base station handovers is predicted to be longer than 180 seconds. It is noted that the MME 300 can decide, based on subscriber information, statistics information, and the like, the “Expected UE Behaviour”. If a time indicated by the “Expected UE Behaviour” (for example, predicted time interval of the inter-base station handover) exceeds a threshold value, the eNB 200 determines that the UE 100 has the low mobility. Otherwise, the eN 200 determines that the UE 100 does not have the low mobility.

It is noted that, if a “HANDOVER REQUEST” message received from a source eNB 200 includes the “Expected UE Behaviour”, the eNB 200 may determine, based on the “Expected UE Behaviour”, whether or not the UE 100 has the low mobility.

In a third method, the eNB 200 determines, based on “extendedLowPowerConsumption”, whether or not the UE 100 has the low mobility. If a message including the “extendedLowPowerConsumption” is received from the UE 100, the eNB 200 determines that the UE 100 has the low mobility. The “extendedLowPowerConsumption” is information indicating that the UE 100 further prefers low power consumption than the “LowPowerConsumption” indicating that the UE 100 prefers the low power consumption. The UE 100 may transmit, to the eNB 200, the “powerPreIndication” including the “extendedLowPowerConsumption” by the “UEAssistanceInformation” message. Alternatively, the UE 100 may include the “extendedLowPowerConsumption” in a field different from the “powerPreIndication” and transmit to the eNB 200 by the “UEAssistanceInformation” message. Alternatively, the Ue 100 may transmit the “extendedLowPowerConsumption” to the eNB 200 by a message different from the UEAssistanceInformation”. Only the UE having a low mobility and/or the UE applying to the MTC may be capable of transmitting the “extendedLowPowerConsumption” to the eNB 200.

In a fourth method, if the extended DRX is configured to the UE 100, or the extended DRX will be configured to the UE 100, the eNB 200 determines that the UE 100 has the low mobility. If the UE 100 has the low mobility, the eNB 200 determines, according to the above-described method, to configure the extended DRX to the UE 100. Alternatively, if the “UEAssistanceInformation” message received from the UE 100 includes the “powerPreIndication”, the eNB 200 determines, based on the “powerPreIndication”, whether or not to configure the extended DRX to the UE 100. The “powerPreIndication” indicates an optimized configuration (preferred by the UE) for power saving. Alternatively, the “powerPreIndication” indicates a normal configuration. If the “powerPreIndication” includes information indicating the “LowPowerConsumption” indicating low power consumption, the eNB 200 may determine to configure the extended DRX to the UE 100.

The eNB 200 may configure the extended DRX to the UE 100 by a conventional PCCH configuration (PCCH-Config.) broadcast to the UE 100 by an SIB2. A value range of a paging cycle (defaultPagingCycle) in the PCCH configuration is extended. The UE 100 handles the paging cycle based on the PCCH configuration as the extended DRX cycle.

Alternatively, the eNB 200 may configure the extended DRX to the UE 100 by an information element (“Idle-eDRX-Config”, for example) different from the conventional PCCH configuration. In the “Idle-eDRX-Config”, a value range such as “ . . . , rf512, rf1024, . . . ” can be configured as the extended DRX cycle. The eNB 200 may configure the extended DRX to the UE 100 by transmitting, to the UE 100, an RRC connection release message including the “Idle-eDRX-Config”, as described later.

In step S120, the eNB 200 transmits the RRC connection release message to the UE 100 without releasing the S1-U bearer between the eNB 200 and the SGW 300B.

Normally, if the eNB 200 detects, based on a configured parameter (inactivity timer), user inactivity indicating that the UE 100 is not activity, it notifies the MME 300A of a request message (UE Context Release Request) for releasing a context of the UE 100 (information on the UE 100). The request message is a message that triggers release of the S1-U bearer. The MME 300A notifies, based on the request message, the SGW 300B of a modify bearer request. The SGW 300B is informed by the modify bearer request that the UE 100 can not utilize the downlink data (downlink traffic). The SGW 300B releases the S1-U bearer in response to reception of the modify bearer request. Further, the SGW 300B transmits, to the MME 300A, a response to the modify bearer request (Modify Bearer Response). The MME 300A notifies the eNB 200 of a UE context release command message (UE Context Release Command) in response to reception of the response to the modified bearer request. The eNB 200 releases the context of the UE 100 in response to reception of the UE context release command. The eNB 200 notifies the MME 300A of a UE context release complete message (UE Context Release Complete) indicating that the context of the UE 100 has been released. After notifying the MME 300A of the UE context release complete message, the eNB 200 transmits the RRC connection release message to the UE 100.

On the other hand, in the present embodiment, the eNB 200 transmits the RRC connection release message to the UE 100 without notifying the MME 300A of the request message. That is, the eNB 200 omits a notification of the request message. Consequently, the S1-U bearer is maintained without being released. The eNB 200 does not notify, if the RRC connection release message is transmitted to the UE 100 having the low mobility, the MME 300A of the request message. That is, the eNB 200 does not notify, if the RRC connection release message is transmitted to the UE 100 to which the DRX using the extended DRX cycle is configured (or will be configured), the MME 300A of the request message.

If the DRX using the extended DRX cycle is not configured to the UE 100, the eNB 200 includes, in the RRC connection release message, configuration information (“Idle-eDRX-Config”) of the DRX (extended DRX) using the extended DRX cycle. If the extended DRX cycle used by the UE 100 is modified, the eNB 200 may transmit, to the UE 100 in which the DRX is configured, the RRC connection release message including the configuration information of the extended DRX. It is noted that, the eNB 200 may transmit, if the configuration information of the extended DRX has already been transmitted to the UE 100, the RRC connection release message not including the configuration information of the extended DRX.

The UE 100, upon receiving the RRC connection release message, releases the RRC connection and transitions to the idle mode. Thereafter, the UE 100 in the idle mode executes the (extended) DRX operation in accordance with a (extended) DRX configuration.

As illustrated in FIG. 7, by releasing the RRC connection, the data radio bearer is released. On the other hand, the S1-U bearer remains present. It is noted that, the EPC 20 (such as the MME 300A and SGW 300B) is not notified of the request message (UE Context Release Request) from the eNB 200, and hence, it is recognized that not only the S1-U bearer, but also the data radio bearer are present (that is, the E-RAB remains present).

It is noted that, the UE 100 has the low mobility, and hence, the UE 100 is assumed to exist in the cell managed by the eNB 200, and the above-described operation is executed.

In step S130, the PGW 400, upon receiving the downlink data addressed to the UE 100, forwards, via the S5/S8 bearer, the downlink data to the SGW 300B.

In step S140, the S1-U bearer of the UE 100 is present, and hence, the SGW 300B, upon receiving the downlink data addressed to the UE 100, forwards, via the S1-U bearer, the downlink data to the eNB 200. The eNB 200 receives, even if the UE 100 is in the idle mode and the data radio bearer is not present, the downlink data addressed to the UE 100.

In step S150, the data radio bearer is not present, and hence, the eNB 200 stores and buffers the downlink data addressed to the UE 100 received from the SGW 300B in the memory 230. The eNB 200 buffers the downlink data before it is transmitted to the UE 100.

In step S160, the eNB 200 decides to execute a RAN paging. Normally, the eNB 200 transmits, if a paging is received from the MME 300A, a paging message to the UE 100 in response to the paging cycle (DRX cycle). On the other hand, the RAN paging is a special paging transmitted from the eNB 200 without receiving a paging from the MME 300A. The eNB 200 transmits, to the UE 100, a special paging message, without receiving a paging from the MME 300A. For example, the eNB 200 transmits, to the UE 100, a paging message including identification information indicating a special paging message, as a special paging message. Alternatively, a special paging message different from a conventional paging message may be defined. The eNB 200 may transmit the special paging message to the UE 100.

In step S170, the eNB 200 transmits, based on the (extended) DRX configuration, the special paging message to the UE 100. The UE 100 monitors the PDCCH at a PDCCH monitoring timing based on the (extended) DRX configuration, and receives the special paging message from the eNB 200.

In step S180, the UE 100 and the eNB 200 establish the RRC connection. The UE 100 establishes the RRC connection by executing a random access process. Consequently, the UE 100 transitions from the idle mode to the connected mode.

Normally, if the paging message is received in the idle mode, the UE 100 notifies, after the RRC connection is established, the MME 300A of a response (a response to the paging) based on the paging message in order to obtain the downlink data. Consequently, the MME 300A knows that the UE 100 has transitioned to the connected mode, and hence, registers location of the UE 100. The SGW 300B knows the location of the UE 100, and hence, forwards the downlink data to the UE 100 and the UE 100 obtains the downlink data.

On the other hand, the UE 100 omits, if receiving the special paging message, a response based on the paging message. That is, the UE 100 does not notify the MME 300A of the response based on the paging message. Even if a normal paging message is received, the UE 100 interprets, if the paging message includes the identification information indicating the special paging message, the paging message as the special paging message. It is noted that, the UE 100 need not omit, even if the special paging message is received, the response based on the paging message.

In step S190, the eNB 200 notifies the UE 100 of an RRC connection reconfiguration message (RRCConnectionReconfiguration), and establishes the data radio bearer between the eNB 200 and the UE 100 which receives the message.

In step S200, the eNB 200 transmits, after the data radio bearer is established, the downlink data to the UE 100. The eNB 200 deletes, if the downlink data is transmitted to the UE 100, the downlink data. The UE 100 receives, after the data radio bearer is established, the downlink data. Consequently, the UE 100 can obtain the downlink data.

As described above, the SGW 300B forwards, via the S1-U bearer, the downlink data to the eNB 200, and hence, need not buffer the downlink data for a long period. Therefore, it is possible to suppress an increase in the buffer capacity of the SGW 300B by buffering the downlink data addressed to the UE.

### Second Embodiment

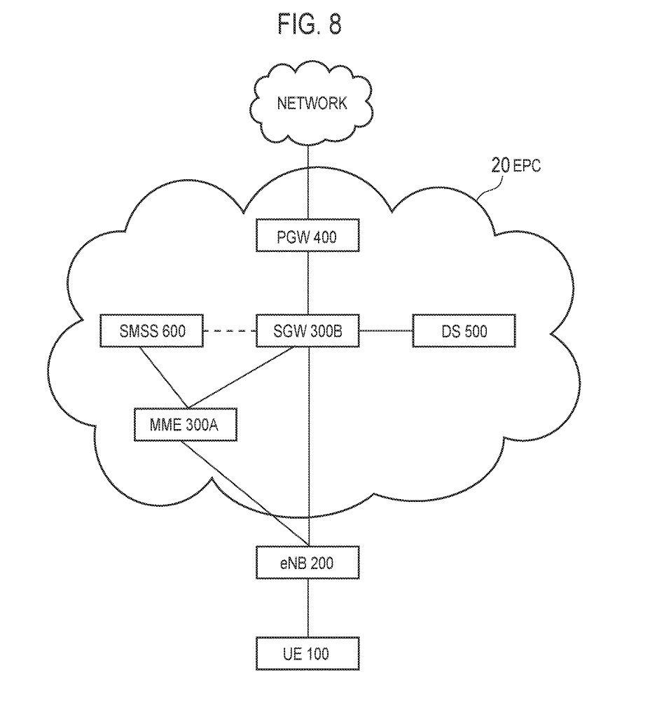

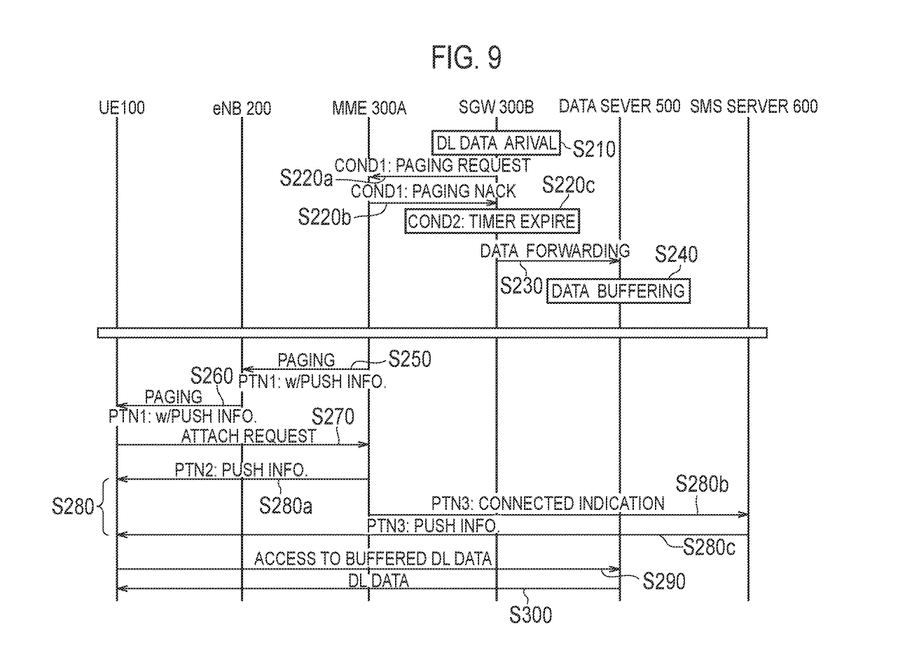

Next, a second embodiment will be described with reference to FIG. 8 and FIG. 9. FIG. 8 is a diagram for describing an operation environment according to the second embodiment. FIG. 9 is a sequence diagram for describing an operation according to the second embodiment. It is noted that the same parts as those in the first embodiment will be omitted, where appropriate.

In the second embodiment, the SGW 300B forwards the downlink data to the data server 500 described later.

As illustrated in FIG. 8, the EPC 20 includes a data server (DS) 500 and an SMS server (SMSS) 600, in addition to the MME 300A, SGW 300B, and the PGW 400. It is noted that the SMSS 600 is provided in the external network, and need not be included in the EPC 20.

The DS 500 is a server configured to buffer and forward the downlink data. As described later, the DS 500 buffers the downlink data forwarded from the SGW 300B. The DS 500 forwards, upon being accessed by the UE 100, the downlink data addressed to the UE 100, to the UE 100.

The DS 500 has a block diagram similar to that of the MME 300A. Therefore, the DS 500 includes a network interface, a memory, and a processor. It is noted that the memory may be integrated with the processor, and this set (that is, a chipset) may be used as a processor. The network interface is connected to the SGW 300B. Further, the network interface is used for communication with the SGW 300B and the UE 100. The memory stores a program executed by the processor, and information used for a process by the processor. The processor includes a baseband processor that performs modulation and demodulation, encoding and decoding and the like on a baseband signal and a CPU that performs various types of processes by executing the program stored in the memory. The processor executes various types of processes and various types of communication protocols described later.

The SMSS 600 is a server configured to notify the UE 100 of an SMS (Short Message service) message. The SMS message is a push type message. Therefore, the SMSS 600 instantly and actively notifies the UE 100 of the SMS message.

The SMSS 600 has a block diagram similar to that of the MME 300A. Therefore, the SMSS 600 includes a network interface, a memory, and a processor. It is noted that the memory may be integrated with the processor, and this set (that is, a chipset) may be used as a processor. The network interface is connected to the MME 300A. The network interface may be connected to the SGW 300B. Further, the network interface is used for communication with the MME 300A (and the SGW 300B) and the UE 100. The memory stores a program executed by the processor, and information used for a process by the processor. The processor includes a baseband processor that performs modulation and demodulation, encoding and decoding and the like on a baseband signal and a CPU that performs various types of processes by executing the program stored in the memory. The processor executes various types of processes and various types of communication protocols described later.

In such an operating environment, the operation illustrated in FIG. 9 is executed. It is noted that, in the initial state of FIG. 9, the UE 100 is in the idle mode, and executes the extended DRX operation in the idle mode. Further, the UE 100 is in the idle mode, and hence, the E-RAB (the data radio bearer and the S1-U bearer) is not present.

As illustrated in FIG. 9, in step S210, the SGW 300B receives, via the S5/S8 bearer, the downlink data addressed to the UE 100, from the PGW 400.

In step S220a, the SGW 300B transmits, in response to reception of the downlink data addressed to the UE 100, a paging request to the MME 300A. Specifically, there is no E-RAB, and hence, the SGW 300B requests the MME 300A to perform paging based on the downlink data.

In step S220b, the MME 300A notifies the SGW 300B of a negative acknowledgment to the paging request (Paging NACK). The MME 300A notifies, if the UE 100 executes the extended DRX operation, the SGW 300B of the negative acknowledgment. The negative acknowledgment includes information with an indication that the UE 100 is executing the extended DRX operation.

The MME 300A determines, if the extended DRX is configured to the UE 100 by a NAS message, that the UE 100 is executing the extended DRX operation. Alternatively, the MME 300A may obtain, from the eNB 200, the information of the UE 100 to which the extended DRX is configured.

Alternatively, the MME 300A transmits a paging to the eNB 200 that cause the eNB 200 to transmit the paging message. Thereafter, if a response to the paging message is not delivered from the UE 100 for a predetermined period, it may be determined that the UE 100 is executing the extended DRX operation.

The SGW 300B executes, if the negative acknowledgment with an indication that the UE 100 is executing the extended DRX operation is received, the process in step S230. Alternatively, the SGW 300B may execute, if the process in step S220c is executed, the process in step S230.

In step S220c, a data buffering timer buffered by the SGW 300B expires. The SGW 300B can start, if the downlink data is received, the data buffering timer. The data buffering timer expires if a predetermined period has elapsed since the SGW 300B buffered the downlink data. The SGW 300B executes, if the data buffering timer expires, that is, if a predetermined period has elapsed since the downlink data was buffered, the process in step S230. Even if the negative acknowledgment is not received, the SGW 300B can execute, if the data buffering timer expires, the process in step S230.

In step S230, the SGW 300B forwards the downlink data to the DS 500. The DS 500 receives the downlink data from the SGW 300B.

In step S240, the DS 500 buffers the received downlink data. That is, the DS 500 stores the downlink data in the memory.

Hereinafter, the MME 300A executes, if the downlink data is forwarded from the SGW 300B to the DS 500, an operation causing the UE 100 to access the DS 500. If the negative acknowledgment including information with an indication that the UE 100 is executing the extended DRX operation is notified to the SGW 300B, the MME 300A can execute the operation. Alternatively, if a predetermined period has elapsed without receiving, from the UE 100, the response based on the paging message corresponding to the paging request, since the paging request was received, the MME 300A can execute the operation. As the operation, the MME 300A can execute at least one operation among the following three patterns.
The MME 300A includes an access instruction in the paging (ptn1).
The MME 300A notifies the UE 100 of the access instruction by the NAS message (ptn2).
The MME 300A notifies, if the response based on the paging message is received from the UE 100, the SMSS 600 of a predetermined message (ptn3).

Details are provided below.

In step S250, the MME 300A notifies, in response to the paging request from the SGW 300B, the paging causing the eNB 200 subordinate to the MME 300A to transmit the paging message. The MME 300A can include the access instruction in the paging, as an operation causing the UE 100 to access the DS 500. It is noted that, if the process in step S280 is executed, the MME 300A need not include the access instruction in the paging.

The access instruction is an instruction causing the UE 100 to access to the DS 500. For example, the access instruction includes an address of a node (or an identifier of the node) that buffers the downlink data. In the present embodiment, the access instruction is an address of the DS 5000. The access instruction may be a push notification which is push type information (push Info).

In step S260, the eNB 200 transmits, if the paging is received from the MME 300A, the paging message to the UE 100, in response to the paging cycle (extended DRX cycle). The eNB 200 includes, if the access instruction is included in the paging from the MME 300A, the access instruction in the paging message.

The UE 100 monitors the PDCCH at the PDCCH monitoring timing based on the extended DRX configuration (extended DRX cycle), and receives the paging message from the eNB 200. The UE 100 receives the access instruction by receiving the paging message including the access instruction. The UE 100 establishes, after receiving the paging message, the RRC connection with the eNB 200.

In step S270, the UE 100 notifies the MME 300A of the response based on the paging message. For example, the UE 100 notifies the MME 300A of an attachment request, as the response. Alternatively, the UE 100 may notify the MME 300A of a service request or “Initial UE Message”, as the response.

In step S280a, the MME 300A can notify the access instruction by the NAS message, in response to reception of the response. Consequently, the UE 100 receives the access instruction by the NAS message.

In step S280b, the MME 300A notifies, if the response is received, a predetermined message (Connected indication). The predetermined message is a message that triggers the SMSS 600 to notify, by the SMS message, the UE 100 of the access instruction. The predetermined message indicates that the UE 100 is connected to the network. Alternatively, the predetermined message indicates that the UE 100 is in the connected mode.

In step S280c, the SMSS 600 notifies, in response to reception of the predetermined message, the UE 100 of the access instruction, by the SMS message.

It is noted that, the process in step S280 including step S280a to S280c may be omitted, if the MME 300A includes the access instruction in the paging.

In step S290, the UE 100 starts, in response to the access instruction, the access to the DS 500.

In step S300, the DS 500 forwards, to the UE 100 which accessed the DS 500, the downlink data addressed to the UE 100. The UE 100 receives the downlink data from the DS 500. Consequently, the UE 100 can obtain the downlink data.

As described above, the SGW 300B forwards the downlink data to the DS 500, and hence, need not buffer the downlink data for a long period. Therefore, it is possible to suppress an increase in the buffer capacity of the SGW 300B by buffering the downlink data addressed to the UE.

### Other Embodiments

In the above-described second embodiment, even if the conventional DRX operation is configured to the UE 100 instead of the extended DRX operation, a similar operation may be executed. For example, the SGW 300B can forward, if the data buffering timer expires, the downlink data addressed to the UE 100 in which the conventional DRX operation is configured, to the DS 500.

In the above-described second embodiment, the SGW 300B forwards the downlink data to the DS 500; however, this is not limiting. The SGW 300B may forward the downlink data to the SMSS 600. In this case, the access instruction is an instruction causing the UE 100 to access the SMSS 600.

The above-described first and second embodiments may be combined.

In each of the above-described embodiments, as one example of a cellular communication system, the LTE system is described; however, the present invention is not limited to the LTE system, and the present invention may be applied to systems other than the LTE system.

### INDUSTRIAL APPLICABILITY

The present invention is useful in the field of communication.

1. A base station used in a communication system including a radio terminal capable of configuring an extended DRX in an idle mode, comprising:
a controller configured to receive, if the radio terminal is in a connected mode, via a bearer between the base station and a serving gateway, downlink data addressed to the radio terminal, from the serving gateway, and to transmit the downlink data to the radio terminal, wherein
the controller does not release but maintains the bearer, if the extended DRX operation is configured to the radio terminal, when the radio terminal transitions to the idle mode, and
the controller receives, even if the radio terminal is in the idle mode, from the serving gateway, the downlink data addressed to the radio terminal, via the bearer, and buffers the downlink data before the downlink data is transmitted to the radio terminal.

2. The base station according to claim 1, wherein
the controller transmits, to the radio terminal, a release message for releasing an RRC connection between the radio terminal and the base station without notifying a mobility management entity of a release request serving as a trigger to release the bearer when the radio terminal transitions to the idle mode.

3. The base station according to claim 1, wherein
the controller transmits, after buffering the downlink data, to the radio terminal, a special paging message transmitted without receiving a paging from a mobility management entity.

4. The base station according to claim 3, wherein
the controller transmits, to the radio terminal, a paging message including identification information indicating the special paging message, as the special paging message.

5. A radio terminal that executes a DRX operation in an idle mode, comprising:
a controller configured to notify a mobility management entity that is an upper node of a base station of a response based on a paging message, if receiving, in the idle mode, the paging message based on downlink data from the base station, after establishing an RRC connection with the base station, wherein
the controller omits, if receiving, from the base station, a special paging message different from the paging message, the response and obtains the downlink data from the base station.

6. The radio terminal according to claim 5, wherein
the controller interprets, if receiving a paging message including identification information indicating the special paging message, the paging message as the special paging message.

7. A radio terminal capable of executing an extended DRX operation in an idle mode, comprising:
a receiver configured to receive, during execution of the extended DRX operation, a paging message based on downlink data addressed to the radio terminal, from a base station; and
a controller configured to establish, after receiving the paging message, an RRC connection with the base station to obtain the downlink data, wherein
the receiver receives an access instruction causing the radio terminal to access a data server configured to buffer and forward downlink data, and
the controller starts the access to the data server in response the access instruction.

8. The radio terminal according to claim 7, wherein
the receiver receives the access instruction by receiving the paging message including the access instruction.

9. The radio terminal according to claim 7, wherein
the receiver receives the access instruction by a NAS message from a mobility management entity that is an upper node of the base station.

10. The radio terminal according to claim 7, wherein
the receiver receives, from an SMS server, the access instruction by an SMS message.
